(19) United States
(12) Patent Application Publication
(10) Pub. No.: US 2026/0288153 A1
(43) Pub. Date: Sep. 24, 2026

(54) SYSTEM FOR RECOGNIZING OBJECT AND CALCULATING DISPLACEMENT BASED ON ARTIFICIAL INTELLIGENCE AND AUTONOMOUS DRIVING SENSOR AND METHOD IMPLEMENTING THE SAME

(71) Applicants: Hyundai Motor Company, Seoul (KR); Kia Corporation, Seoul (KR)

(72) Inventor: Won Je JANG, Hwaseong-Si (KR)

(21) Appl. No.: 19/337,030

(22) Filed: Sep. 23, 2025

(30) Foreign Application Priority Data
Mar. 20, 2025 (KR) 10-2025-0035973

(51) Int. Cl. G05D 1/633; B60W 40/02; B60W 60/00

(52) U.S. Cl. CPC G05D 1/633; B60W 40/02; B60W 60/0015; B60W 2554/404

(57) ABSTRACT

An apparatus of a vehicle may comprise a processor and a memory storing at least one instruction that, when executed by the processor communicating with the memory, is configured to cause the apparatus to generate first shape information related to a first predicted bounding box (P-Box) and second shape information related to a second P-Box, determine a plurality of candidate transition matrices representing displacement values between the P-Boxes, determine a reliability score for each candidate transition matrix based on an LF-based line distance or a PF-based point distance, select a transition matrix based on the reliability score, output a signal indicating the displacement value, and control, based on the signal, autonomous driving of the vehicle.

### CROSS-REFERENCE TO RELATED APPLICATION

This application claims the benefit of priority to Korean Patent Application No. 10-2025-0035973, filed with the Korean Intellectual Property Office on Mar. 20, 2025, the entire contents of which are incorporated herein by reference.

### TECHNICAL FIELD

The present disclosure relates to a system and method for recognizing an object and determining displacement using an artificial intelligence (AI) and an autonomous driving sensor, and more particularly, to a system and method capable of determining a displacement value based on shape information of a P-Box to accurately measure an amount of movement and velocity of an object.

### BACKGROUND

With the development and commercialization of autonomous vehicles, the use of various sensors and artificial intelligence (AI) technologies to support autonomous driving functions of vehicles is increasing. For example, research is ongoing into what object exists in front of a moving vehicle, what the distance is between the object and the vehicle, and what algorithm the vehicle should use to respond to specific situations to ensure safety.

Accordingly, vehicle sensor technology is becoming more advanced, and high-performance sensors such as light detection and ranging (LiDAR) that recognizes a surrounding environment using a laser beam, radio detection and ranging (RADAR) that uses radio waves, ultrasonic sensors, fisheye cameras capable of shooting 360-degree images, multifocal lenses, and a global positioning system (GPS) are being installed in a vehicle.

As above, by aggregating measurement results obtained from a plurality of sensors, it has become possible to implement a super sensor vehicle. In self-driving (autonomous driving), concept of a super sensor refers to a technology that seeks to more accurately recognize the surrounding environment by combining measurements from various sensors rather than relying on individual sensors for convenience and safety of driving. With the addition of information and communications technology (ICT) and cloud technology, sensors and AI algorithms required for autonomous driving are becoming more sophisticated than ever before, not only for a single vehicle, but also for a fleet of vehicles, remotely accumulating data and training AI servers and databases to increase reliability of vehicle sensor determination.

Among these, a LiDAR sensor, used to recognize external environments, emit lasers and measures the time it takes for reflection and intensity of the reflected lasers, thereby identifying various objects present on the road during autonomous driving.

Object recognition using a LIDAR and an AI algorithm may not be accurate. A method and apparatus to enhance accuracy of recognizing an object and measuring an amount of movement (i.e., velocity) of the object are considered.

### SUMMARY

The present disclosure relates to a system and method for recognizing an object and determining displacement using an artificial intelligence (AI) and an autonomous driving sensor, and more particularly, a main technical task is to implement a system and method capable of determining a displacement value based on shape information of a P-Box to accurately measure an amount of movement and velocity of an object.

Of course, the technical problems of the present disclosure are not limited to the technical problems mentioned above, and other technical problems not explicitly mentioned will be clearly understood by those skilled in the art from the detailed description of the present disclosure and the attached drawings.

In order to solve all or at least part of the above-described technical problems, the present disclosure may be implemented in various examples as follows.

According to the present disclosure, an apparatus of a vehicle, the apparatus may comprise, a processor, and, a memory storing at least one instruction that, when executed by the processor communicating with the memory, is configured to cause the apparatus to, generate first shape information related to a first predicted bounding box (P-Box), wherein the first P-Box is obtained by incorporating a current line feature (LF) and a current point feature (PF) of an object in a surrounding environment of the vehicle, generate second shape information related to a second P-Box, wherein the second P-Box is obtained by incorporating a past LF and a past PF of the object, wherein the object is recognized based on multiple point data input from a sensor of the vehicle, and wherein the multiple point data input is part of an artificial intelligent model, based on the first shape information and the second shape information, determine a plurality of candidate transition matrices that provisionally represent displacement values between the first P-Box and the second P-Box, based on an LF-based line distance or a PF-based point distance, determine, for each of the plurality of candidate transition matrices, a reliability score, select, based on the reliability score, a transition matrix among the plurality of candidate transition matrices, wherein the transition matrix represents a displacement value between the first P-Box and the second P-Box, output a signal indicating the displacement value, and control, based on the signal, autonomous driving of the vehicle.

The apparatus, wherein the at least one instruction that, when executed by the processor communicating with the memory, is configured to cause the apparatus to generate the first shape information and the second shape information by adjusting an alignment order between the current LF, the current PF, the past LF, and the past PF. The apparatus, wherein the at least one instruction that, when executed by the processor communicating with the memory, is configured to cause the apparatus to measure the current PF and the past PF by setting a reference point, wherein the reference point is a point, among points represented by the multiple point data, closest to the sensor.

The apparatus, wherein a candidate transition matrix, X, of the plurality of candidate transition matrices, is determined such that the first shape information corresponding to matrix B and the second shape information corresponding to matrix A satisfy the following relationship,
and X is determined as,

$$A = X \cdot B$$

$$X = A \cdot {B}^{- 1} .$$

The apparatus, wherein the candidate transition matrix, X, is determined by a singular value decomposition (SVD) process based on, a product of the matrix A, an m×m complex unitary matrix associated with the matrix B, an m×n diagonal matrix associated with the matrix B, and an n×n complex unitary matrix associated with the matrix B.

The apparatus, wherein the at least one instruction that, when executed by the processor communicating with the memory, is configured to cause the apparatus to generate the plurality of candidate transition matrices by comparing positional information included in each of the first shape information and the second shape information. The apparatus, wherein the at least one instruction that, when executed by the processor communicating with the memory, is configured to cause the apparatus to determine the reliability score by rotating the first shape information such that a heading of the first shape information is aligned with a heading of the second shape information prior to determining the reliability score.

The apparatus, wherein the LF-based line distance, LineDist[i], is determined for ith candidate transition matrix among the plurality of candidate transition matrices according to Equation 3,

$$LineDist [ i ] = ( {d}_{1} + {d}_{2} ) + ( {d}_{1}^{′} + {d}_{2}^{′} ) + dist \frac{( \tilde{p} + \tilde{q} )}{2} , \frac{( {P}_{d} + {Q}_{d} )}{2} ) \qquad [ Equation 3 ]$$

wherein, Pd and Qd are endpoints of a line segment corresponding to the current LF, \tilde{p} and \tilde{q} are endpoints of a line segment corresponding to the past LF, d₁ is a perpendicular distance from Pd to a line segment defined by \tilde{p} and \tilde{q}, d₂ is a perpendicular distance from Qd to the line segment defined by \tilde{p} and \tilde{q}, d′₁ is a perpendicular distance from \tilde{p} to a line segment defined by Pd and Qd, d′₂ is a perpendicular distance from \tilde{q} to the line segment defined by Pd and Qd, and dist (x, y) denotes a Euclidean distance between points x and y.

The apparatus, wherein the PF-based point distance, PointDist[i], is determined for ith candidate transition matrix among the plurality of candidate transition matrices according to Equation 4,

$$PointDist = dist ( \tilde{p} , {P}_{d} ) + d i s t ( \tilde{q} , {Q}_{d} ) \qquad [ Equation 4 ]$$

wherein, Pd and Qd are endpoints of a line segment corresponding to the current LF, \tilde{p} and \tilde{q} are endpoints of a line segment corresponding to the past LF, and dist (x, y) denotes a Euclidean distance between points x and y.

The apparatus, wherein the at least one instruction that, when executed by the processor communicating with the memory, is configured to cause the apparatus to, based on a difference in length between the first shape information and the second shape information exceeding a threshold value, apply a weighting factor w to adjust a result of Equation 3.

According to the present disclosure, a method performed by an apparatus of a vehicle, the method may comprise, generating first shape information related to a first predicted bounding box (P-Box), wherein the first P-Box is obtained by incorporating a current line feature (LF) and a current point feature (PF) of an object in a surrounding environment of the vehicle, generating second shape information related to a second P-Box, wherein the second P-Box is obtained by incorporating a past LF and a past PF of the object, wherein the object is recognized based on multiple point data input from a sensor of the vehicle, and wherein the multiple point data input is part of an artificial intelligent model, based on the first shape information and the second shape information, determining a plurality of candidate transition matrices that provisionally represent displacement values between the first P-Box and the second P-Box, based on an LF-based line distance or a PF-based point distance, determining, for each of the plurality of candidate transition matrices, a reliability score, selecting, based on the reliability score, a transition matrix among the plurality of candidate transition matrices, wherein the transition matrix represents a displacement value between the first P-Box and the second P-Box, outputting a signal indicating the displacement value, and controlling, based on the signal, autonomous driving of the vehicle. The method, wherein the generating of the first shape information and the second shape information may comprise adjusting an alignment order between the current LF, the current PF, the past LF, and the past PF.

The method may further comprise, measuring the current PF and the past PF by setting a reference point, among points represented by the multiple point data, closest to the sensor. The method, wherein a candidate transition matrix, X, of the plurality of candidate transition matrices, is determined such that the first shape information corresponding to matrix B, and the second shape information corresponding to matrix A satisfy the following relationship,
and X is determined as,

$$A = X \cdot B$$

$$X = A \cdot {B}^{- 1} .$$

The method, wherein the candidate transition matrix, X, is determined by a singular value decomposition (SVD) process based on, a product of the matrix A, an m×m complex unitary matrix associated with the matrix B, an m×n diagonal matrix associated with the matrix B, and an n×n complex unitary matrix associated with the matrix B. The method may further comprise, generating the plurality of candidate transition matrices by comparing positional information included in each of the first shape information and the second shape information.

The method, wherein the determining of the reliability score may comprise rotating the first shape information such that a heading of the first shape information is aligned with a heading of the second shape information prior to determining the reliability score.

According to the present disclosure, a vehicle may comprise, a sensor, a driving control circuit configured to control autonomous driving of the vehicle, a processor, and, a memory storing at least one instruction that, when executed by the processor communicating with the memory, is configured to cause the vehicle to, obtain, via the sensor, point cloud data representing objects in a surrounding environment of the vehicle, identify, from the point cloud data, a target object, generate, for the target object, a present box feature, wherein the present box feature may comprise line features and point features corresponding to a current shape of the target object, retrieve, from the memory, a past box feature associated with the target object, wherein the past box feature may comprise line features and point features corresponding to a previous shape of the target object, generate a plurality of candidate transition matrices representing potential displacements between the present box feature and the past box feature, determine a reliability score for each candidate transition matrix of the plurality of candidate transition matrices, based on the reliability scores, select, from the plurality of candidate transition matrices, a transition matrix as an estimated displacement of the target object, output a signal indicating the estimated displacement of the target object, and control, via the driving control circuit and based on the signal, autonomous driving of the vehicle.

The vehicle, wherein the at least one instruction, when executed by the processor communicating with the memory, is configured to, prior to generation of the plurality of candidate transition matrices, cause the vehicle to adjust an alignment order between, the line features and point features of the present box feature, and the line features and point features of the past box feature.

The vehicle, wherein the at least one instruction, when executed by the processor communicating with the memory, is configured to cause the vehicle to, based on a difference in length between the present box feature and the past box feature exceeding a threshold, apply a weighting factor to the reliability score.

### BRIEF DESCRIPTION OF THE DRAWINGS

FIG. 1 shows an example overall system for automatically recognizing objects and controlling a vehicle for purposes such as autonomous driving.

FIG. 2 shows an example algorithm for recognizing an object and measuring a displacement using multiple point data input from an AI module and an autonomous driving sensor.

FIG. 3 shows an example view for describing components of a box feature point used for displacement measurement.

FIG. 4 shows an example view for describing a method of aligning shape information of a P-Box prior to displacement measurement.

FIG. 5A, FIG. 5B, and FIG. 5C show example views for describing various methods of determining a plurality of candidate transition matrices that provisionally represent displacement values between a first P-Box and a second P-Box.

FIG. 6 shows an example process of overlapping box shapes for displacement measurement.

FIG. 7 shows an example view visually representing various variables used in LF distance and PF distance determination.

FIG. 8 shows an example view for describing a reason for introducing weights to deal with errors that may occur in reliability measurement based on an LF distance.

FIG. 9 shows an example view of comparing a lateral component of a displacement (i.e., velocity converted per unit time) actually measured according to an example of the present disclosure with that of a displacement measured according to other approach.

FIG. 10 shows an example computing system for autonomous vehicle control and object recognition computation.

### DETAILED DESCRIPTION

Hereinafter, some examples of the present disclosure will be described in detail with reference to exemplary drawings. It should be noted that in adding reference numerals to constituent elements of each drawing, the same constituent elements include the same reference numerals as possible even though they are indicated on different drawings. Furthermore, in describing examples of the present disclosure, in a case where it is determined that detailed descriptions of related well-known configurations or functions interfere with understanding of the examples of the present disclosure, the detailed descriptions thereof will be omitted.

In describing constituent elements according to various examples of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those skilled in the technical field to which an example of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification. For example, in the present disclosure, the term ‘object’ essentially holds same meaning as ‘entity,’ and the expressions ‘object’ and ‘entity’ will be interchangeably used throughout the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of estimating object movement by comparing shape data at different times) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of estimating object movement by comparing shape data at different times) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of estimating object movement by comparing shape data at different times) described herein.

Minimum risk maneuver (MRM) operation(s) may also be controlled, for example, based on one or more features (e.g., feature of estimating object movement by comparing shape data at different times) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of estimating object movement by comparing shape data at different times) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of estimating object movement by comparing shape data at different times) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., feature of estimating object movement by comparing shape data at different times) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

The disclosed technology may enable a vehicle to accurately recognize and track surrounding objects using artificial intelligence (AI) and sensors, particularly LiDAR, which generates three-dimensional maps of the environment. It may be challenging for autonomous vehicles to determine the extent and velocity of movement of nearby objects, especially when such objects rapidly change shape or position. The present disclosure addresses these challenges by creating more accurate way to measure the movement (e.g., displacement) and speed or velocity. It does so by breaking down a shape of an object into line and point features (e.g., by generating a bounding box), comparing these features across different time points, and applying various techniques—including matrix operations and reliability scoring—to estimate object displacement and pick the best possible estimate for how the object moved. This approach improves the precision of object tracking by the vehicle's control system and reduces errors in motion estimation, thereby enhancing the safety and reliability of autonomous driving.

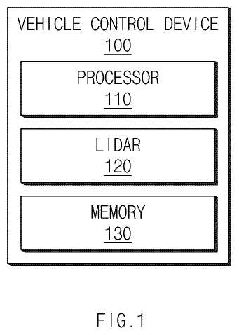

FIG. 1 shows an example shows an example overall system for automatically recognizing objects and controlling a vehicle for purposes such as autonomous driving.

Referring to FIG. 1, a vehicle control apparatus 100 according to an example of the present disclosure may be implemented inside or outside a vehicle, and some of the components included in the vehicle control apparatus 100 may be implemented inside or outside the vehicle. In the instant case, the vehicle control apparatus 100 may be integrally formed with internal control units of the vehicle, or may be implemented as a separate device to be connected to control units of the vehicle by a separate connection means. For example, the vehicle control apparatus 100 may further include components not shown in FIG. 1.

The vehicle control apparatus 100 according to an example may include a processor 110, a LiDAR 120, and a memory 130. The processor 110, the lidar 120, or the memory 130 may be electronically and/or operably coupled with each other by an electronic component including a communication bus.

Hereinafter, hardware components being operatively coupled may include a direct connection, and/or an indirect connection established between the components, wired, and/or wireless, such that a second component is controlled by a first component among the components.

Although they are illustrated in different blocks, the examples are not limited thereto. For example, some of the hardware components in FIG. 1 may be included in a single integrated circuit including a system on a chip (SoC). A type and/or number of hardware components included in the vehicle control apparatus 100 is not limited to that shown in FIG. 1. For example, the vehicle control apparatus 100 may include some of the components illustrated in FIG. 1.

The vehicle control apparatus 100 according to an example may include hardware for processing data based on one or more instructions. For example, the hardware for processing data may include a processor 110. For example, the hardware for processing data may include an arithmetic and logic unit (ALU), a floating point unit (FPU), a field programmable gate array (FPGA), a central processing unit (CPU), and/or an application processor (AP). The processor 110 may be configured to have a single-core processor structure, or a multi-core processor structure including dual core, quad core, hexa core, or octa core (e.g., depending on the computational complexity of perception models, route planning, or control logic, etc.).

According to another example, the processor 110 may be configured to include at least one of a graphic processing unit (GPU), a neural processing unit (NPU), or any combination thereof. For example, the GPU may be referred to as a visual processing unit (VPU). For example, the NPU may be referred to as a neural network processing unit.

The vehicle control apparatus 100 according to an example may include a depth sensor for detecting external objects. For example, the depth sensor for detecting external objects may include at least one of a time of flight (ToF) sensor, a light detection and ranging (LiDAR) 120, a structured light sensor, an ultrasonic sensor, an infrared sensor, a radio detection and ranging (RADAR), an optical distance sensor, or any combination thereof (e.g., combining LiDAR and RADAR to improve robustness in low-visibility conditions, etc.). Hereinafter, for better understanding and ease of description, a description will focus on the LiDAR.

The vehicle control apparatus 100 according to an example may include a LIDAR 120 that acquires a plurality of points based on a pulse laser signal. For example, the LiDAR 120 may acquire data sets that identify objects surrounding the vehicle control apparatus 100 (or a vehicle including the vehicle control apparatus 100). For example, the LiDAR 120 may identify at least one of a position, a moving direction, a velocity, or any combination thereof of a surrounding object based on the pulse laser signal emitted from the LiDAR 120 being reflected back by the surrounding object (e.g., a nearby vehicle, a pedestrian, a tree, or a building, etc.).

For example, the LiDAR may obtain data sets representing external objects in a space formed by an x-axis, a y-axis, and a z-axis based on the pulse laser signal reflected from the surrounding object. For example, the LiDAR 120 may acquire data sets including a plurality of points in the space formed by the x-axis, the y-axis, and the z-axis based on receiving the pulse laser signal every designated period (e.g., every 100 milliseconds, every sensor frame, or at a refresh rate of 10 Hz, etc.). For example, the points may include points representing external objects within a 3D virtual coordinate system. The 3D virtual coordinate system may include at least one of a vehicle coordinate system, a lidar coordinate system, or any combination thereof. However, an example of the 3D virtual coordinate system is not limited to those described above (e.g., it may include a world coordinate system or a map-based coordinate system, etc.).

The memory 130 of the vehicle control apparatus 100 according to an example may include a hardware component for storing data and/or instructions input to and/or output from the processor 110 of the vehicle control apparatus 100. For example, the memory 130 may include a volatile memory including a random-access memory (RAM), and/or a nonvolatile memory including a read-only memory (ROM).

For example, the volatile memory may include at least one of a dynamic RAM (DRAM), a static RAM (SRAM), a Cache RAM, a pseudo SRAM (PSRAM), or any combination thereof. For example, the nonvolatile memory may include at least one of a programmable ROM (PROM), an erasable PROM (EPROM), an electrically erasable PROM (EEPROM), a flash memory, a hard disk, a compact disc, a solid state drive (SSD), an embedded multi-media card (eMMC), or any combination thereof (e.g., depending on cost, size, write endurance, or access speed, etc.).

Within the memory 130 of the vehicle control apparatus 100, one or more instructions (or commands) indicating computations and/or actions to be performed by the processor 110 of the vehicle control apparatus 100 based on data may be stored. A set of one or more instructions may be referred to as a program, a firmware, an operating system, a process, a routine, a sub-routine, and/or an application (e.g., an object detector, a SLAM module, or a LiDAR segmentation engine, etc.).

Hereinafter, a point that an application is installed in a vehicle control apparatus 100 may indicate that one or more instructions provided in a form of an application are stored in the memory 130, and that one or more applications are stored in a format that is executable by the processor 110 of the vehicle control apparatus 100 (e.g., a file having an extension designated by an operating system of the vehicle control apparatus 100) (e.g., a binary executable file, or a compiled library, etc.).

For example, the memory 130 may include a first neural network model for detecting an object. For example, the memory 130 may include a second neural network model for outputting types of the points acquired by the lidar 120 and/or scores of the points (e.g., object class scores or distance likelihoods, etc.).

In an example, the processor 110 may be configured to obtain at least one of a first virtual box representing a target object, a first class representing a type of the target object, or any combination thereof, based on the points acquired through the LIDAR 120 and the first neural network model stored in the memory 130.

For example, the processor 110 may be configured to obtain at least one of a first virtual box representing a target object, a first class representing a type of the target object, or any combination thereof, based on inputting a plurality of points into the first neural network model. For example, the first neural network model may include an object detection model (e.g., a 3D bounding box detector or a center-based detection network, etc.). For example, the target object may include an external object positioned within a designated distance from the vehicle control apparatus 100 (or a vehicle including the vehicle control apparatus 100) (e.g., within a 50-meter range in the forward direction, etc.). For example, the target object may include an object that is identified by the vehicle control apparatus 100 and is continuously tracked. For example, the type of the target object may include multiple types for classifying the target object. For example, the type of the target object may include at least one of a first type representing a ground, a second type representing a type that is different from the ground, or any combination thereof. However, the type of the target object is not limited to what was described above. For example, the type of the target object may include at least one of a third type representing a person, a fourth type representing a vehicle, or any combination thereof (e.g., a bicycle, a traffic cone, a tunnel wall, or a construction sign, etc.), but the present disclosure is not limited thereto.

In an example, the processor 110 may be configured to obtain, based on the points and the second neural network model, at least one of first partial points corresponding to at least a portion of the target object among the points, a second class identified through the first partial points and indicating the type of the target object, or any combination thereof. For example, the second neural network model may include a segmentation model (e.g., a range-view CNN, a point-based classifier, or a sparse voxel network, etc.).

For example, the second neural network model may include a neural network model for obtaining types of multiple points and scores of the points (e.g., softmax outputs, probability heatmaps, or class activation scores, etc.).

For example, the processor 110 may be configured to obtain first partial points corresponding to at least a portion of the target object among the points based on inputting the points into the second neural network model. For example, the processor 110 may be configured to identify the types of the points based on inputting the points into the second neural network model. For example, the processor 110 may be configured to obtain first partial points corresponding to at least a portion of the target object from among the points based on the type of each of the points (e.g., classifying some points as belonging to a vehicle, pedestrian, or roadside object, etc.).

In an example, the processor 110 may be configured to perform a first designated algorithm on the points. For example, the processor 110 may be configured to perform the first designated algorithm for classifying a type of each of the points for the points, for example, within the LiDAR data frame. For example, the processor 110 may be configured to classify second partial points corresponding to a designated type among the points. For example, the designated type may include a type representing the ground (e.g., pavement, crosswalks, or flat surfaces, etc.).

For example, the processor 110 may be configured to classify the second partial points corresponding to a designated type based on performing the first designated algorithm on the points and obtain (or identify) the first partial points by excluding the second partial points from among the points (e.g., separating above-ground structures from terrain, etc.).

For example, the processor 110 may be configured to obtain at least one of a partial class for obtaining a second class, a score for each of the points, or any combination thereof, based on inputting the points into the second neural network model. For example, the processor 110 may be configured to obtain a partial class and a score for each of the points based on inputting the points into the second neural network model. For example, the partial class may contain a classification of each of the points into an arbitrary type (e.g., tree, vehicle, pedestrian, or unknown, etc.).

For example, the processor 110 may be configured to fuse the partial class, the scores of each of the points, and the second partial points (e.g., for joint feature enhancement or confidence weighting, etc.). For example, the processor 110 may be configured to perform clustering based on fusing the partial class, the scores of each of the points, and the second partial points. For example, the clustering may involve grouping first partial points that correspond to at least a portion of the target object (e.g., to generate an instance-level region for bounding box generation, etc.).

For example, the processor 110 may be configured to obtain a point cloud for generating a second virtual box based on the first partial points. For example, the processor 110 may be configured to obtain the point cloud based on grouping the first partial points (e.g., using spatial proximity, density thresholding, or Density-Based Spatial Clustering of Applications with Noise (DBSCAN), etc.).

For example, the processor 110 may be configured to generate a second virtual box, different from the first virtual box and for representing the target object, based on the point cloud. For example, the second virtual box may include a box that includes at least some of the first partial points (e.g., tightly fitted to the object's spatial extent, etc.).

For example, the processor 110 may be configured to identify a heading direction indicating a traveling direction of the target object based on at least one of the first partial points, the point cloud, or any combination thereof (e.g., using temporal point shifts or bounding box orientation, etc.).

For example, the processor 110 may be configured to identify a position of a second virtual box in a virtual coordinate system based on at least one of the first partial points, the point cloud, or any combination thereof (e.g., by computing the centroid of the clustered points, using a bounding box anchor, or referencing vehicle-relative coordinates, etc.). For example, the processor 110 may be configured to identify a size of the second virtual box based on at least one of the first partial points, the point cloud, or any combination thereof (e.g., by estimating width, height, and depth based on point dispersion or statistical spread, etc.).

For example, the processor 110 may be configured to identify a second class based on at least one of the first partial points, the point cloud, or any combination thereof (e.g., classifying as car, pedestrian, traffic cone, or unknown, etc.). For example, the processor 110 may be configured to identify at least one of the heading direction indicating the traveling direction of the target object, a position of the second virtual box in the virtual coordinate system, the size of the second virtual box, the second class, or any combination thereof, based on at least one of the first partial points, the point cloud, or any combination thereof (e.g., to aid in trajectory prediction, collision risk estimation, or classification confidence, etc.).

For example, the processor 110 may be configured to identify the heading direction of the bounding box based on at least one of the first virtual box, the first class, the heading direction of the second virtual box, the position of the second virtual box, the size of the second virtual box, the second class, or any combination thereof (e.g., by tracking box orientation over time, using direction vectors, or aligning with lane markings, etc.). For example, the processor 110 may be configured to identify a position of the bounding box in the virtual coordinate system based on at least one of the first virtual box, the first class, the heading direction of the second virtual box, the position of the second virtual box, the size of the second virtual box, the second class, or any combination thereof (e.g., using Kalman filtering, relative coordinate mapping, or GPS reference data, etc.).

For example, the processor 110 may be configured to obtain a third class indicating a type of the target object corresponding to the bounding box based on at least one of the first virtual box, the first class, the heading direction of the second virtual box, the position of the second virtual box, the size of the second virtual box, the second class, or any combination thereof (e.g., refining classification using fusion from multiple frames, object hierarchy rules, or semantic context, etc.). For example, the processor 110 may be configured to obtain at least one of the heading direction of the bounding box, the position of the bounding box in the virtual coordinate system, the third class indicating the type of the target object corresponding to the bounding box, or a combination thereof, based on at least one of the first virtual box, the first class, the heading direction of the second virtual box, the position of the second virtual box, the size of the second virtual box, the second class, or a combination thereof (e.g., for generating object tracks, scene graphs, or vehicle control cues, etc.).

For example, the processor 110 may be configured to assign a first identifier to the second virtual box for tracking the second virtual box (e.g., a unique ID based on timestamp, class, or location hash, etc.). For example, the processor 110 may be configured to assign a second identifier corresponding to the first identifier to the bounding box (e.g., to maintain identity consistency between detection and tracking outputs, etc.).

For example, the processor 110 may be configured to track the bounding box using the second identifier. For example, the processor 110 may be configured to track the target object based on identifying a plurality of bounding boxes that include a bounding box to which the second identifier is assigned, in a plurality of frames (e.g., through temporal association or object re-identification, etc.). For example, the second identifier may be identifier assigned to a bounding box corresponding to the target object, so the processor 110 may be configured to track the target object by identifying the bounding boxes to which the second identifier is assigned in the frames (e.g., over multiple sensor cycles or time steps, etc.).

In an example, the processor 110 may be configured to output a bounding box corresponding to the target object based on at least one of the first virtual box, the first class, the first partial points, the second class, or any combination thereof (e.g., as a hexahedral 3D box, 2D projected box, or directional polygon, etc.). For example, the bounding box may include an example of the target object represented in the virtual coordinate system in the form of a hexahedron (e.g., defined by eight corner points in 3D space, etc.).

Hereinafter, operations performed by a CPU, a GPU, and/or a NPU included in the processor 110 will be briefly described.

In an example, the processor 110 may be configured to include at least one of a CPU, a GPU, an NPU, or any combination thereof. For example, at least one of the GPU, the NPU, or any combination thereof may obtain the first virtual box and the first class based on the first neural network model (e.g., a region proposal network, transformer-based model, or YOLO-like detector, etc.). For example, at least one of the GPU or the NPU may acquire the first virtual box and the first class. For example, at least one of the GPU, the NPU, or any combination thereof may obtain scores for each of the partial classes and the points for obtaining the second class based on the second neural network model. For example, at least one of the GPU or the NPU may obtain scores for each of the partial classes and the points for obtaining the second class based on the second neural network model (e.g., probability distributions over semantic labels, etc.). For example, the CPU may classify second partial points corresponding to a designated type among the points based on performing the first designated algorithm for classifying types of each of the points for the points (e.g., such as distinguishing ground, non-ground, or noise points, etc.).

As described above, the vehicle control apparatus 100 according to an example may be configured to include at least one processor 110. The vehicle control apparatus 100 may be configured to accurately detect a target object by detecting the target object using at least one processor 110. Additionally, by performing parallel processes, the vehicle control apparatus 100 may be configured to reduce a load on each processor (e.g., enabling real-time LiDAR segmentation and object tracking, etc.).

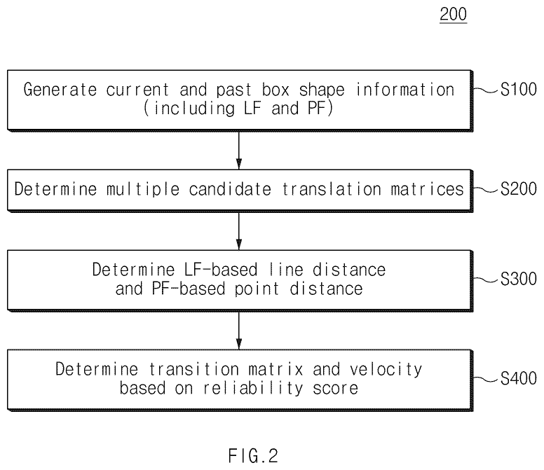

Before describing FIG. 2, a following description is added to provide a comprehensive understanding of AI object recognition according to the present disclosure, specifically regarding LiDAR-based object recognition.

An object recognition process by the LiDAR 120 and an AI module goes through three operations: preprocessing, segmentation, and tracking. For example, AI module may include and execute one or more AI models (e.g., neural networks) for preprocessing, segmentation, and tracking (e.g., detecting road surfaces, identifying vehicle outlines, or following pedestrian movement, etc.).

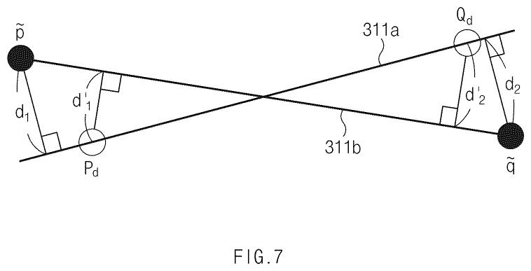

An object recognition system 1000 (see FIG. 7) according to the present disclosure goes through a preprocessing process before executing the object recognition function. The preprocessing may include, e.g., removing points forming the ground based on laser sensing data (i.e., unprocessed raw data) input from the LIDAR 120. For example, this may involve filtering out reflections from roads, sidewalks, or parking lots, etc. A laser beam reflected from the ground may be mistakenly recognized as if there is an object on the ground. Therefore, a process of distinguishing between the ground and non-ground objects (e.g., using height thresholds, surface slope calculations, or clustering techniques, etc.) may be performed during preprocessing, and if necessary, may also be performed during segmentation.

In short, the preprocessing in AI object recognition may be understood as a process in which an image processing tool of the AI module in a processor 110 removes noise from a LiDAR point cloud image and reduces a total number of points existing in the LiDAR point cloud image through, e.g., a voxel downsampling technique to improve a computational efficiency (e.g., by keeping only representative points, aggregating data within a cubic region, or discarding outliers, etc.).

For reference, a LiDAR point cloud image may also be displayed in a bird's eye view (BEV) mode. For example, in a case where a LIDAR map is created to resemble a bird's eye view of a city while flying in the sky, it is called a BEV image (e.g., as seen in autonomous vehicle simulations, mapping drones, or urban planning tools, etc.).

For example, as described above, the LiDAR 120 may emit a laser beam into a surrounding environment, record a time it takes for the laser beam to be reflected by an external object and returns, thereby generating a point for each of numerous laser signals and determining a distance to that point. By continuously emitting numerous laser beams, the processor 110 may be configured to generate a real-time LiDAR map of the surrounding environment as a three-dimensional map of the BEV type, and as a two-dimensional map in other cases (e.g., for pedestrian detection, collision avoidance, or lane keeping, etc.).

In the LiDAR point cloud map, the lines or surfaces appearing in black and white may actually be formed of an innumerable number of points, each of which is generated by the laser beams of the LiDAR 120, and for this reason, a LIDAR sensing image is also referred to as a LIDAR point cloud image. Of course, for example, by combining an RGB-D (Red, Green, Blue-Depth) sensor with a LiDAR sensor, a LIDAR point cloud image may be reconstructed in color (e.g., to improve object classification, visualize environments for augmented reality, or assist in remote inspection, etc.).

It is challenging for a human to recognize objects using individual points within a LIDAR point cloud image; however, by synthesizing the point cloud from perspectives such as a BEV or 2D plan view, it may become possible to roughly estimate the appearance of the surrounding environment of the vehicle currently in an autonomous driving mode. Furthermore, it may be possible to recognize a vehicle, a bus, a pedestrian, a street tree, a traffic sign, a cyclist, or construction barriers, etc. within the LiDAR point cloud image, and in AI image recognition technology, these human and things are referred to as objects, and each object may be classified into a specific group, known as a class, such as a vehicle class, a bus class, a pedestrian class, or a sign class, etc.

Distinguishing which object in the LiDAR point cloud image belongs to the vehicle class or the bus class may require assistance of a deep AI neural network. To detect objects within the LiDAR point cloud image through the AI neural network and identify their classes, AI training may have to be conducted beforehand (e.g., using labeled datasets, supervised learning, or data augmentation, etc.).

For example, the dataset called PANDASET™ may include over 48,000 camera images (mostly taken in the Silicon Valley area of the United States) and more than 16,000 LIDAR scan images, which are annotated with a total of 28 classes, including pedestrians, passenger vehicles, bicycles, construction site signs, and traffic signs (e.g., stop signs, yield signs, or pedestrian crossing signs, etc.).

Furthermore, an LiDAR point cloud image may be visualized according to a user-selected option using a point cloud processing tool such as Open3D™. The LIDAR 120 may be capable of distance detection, so a 3D LiDAR image may be rendered more realistically during visual processing with a tool like Open3D™, and for instance, an object at a greater distance may be displayed in dark blue, while a closer object may be shown in light blue (e.g., rendering distant trees in blue and nearby vehicles in bright blue, etc.).

Furthermore, as mentioned above, an original LiDAR image (i.e., raw data) may be preprocessed by applying a technique called voxel (3D pixel) downsampling to the LiDAR point cloud image. Herein, a voxel (volumetric pixel) refers to a cube-shaped 3D pixel, and the voxel down-sampling may be a technique used to reduce a number of points in the LiDAR point cloud while maintaining structures of various objects included therein, but reducing or minimizing excessive AI computation requirements.

The LiDAR 120 may emit m laser beams n times during a single scan cycle, and scan values of the laser beams that collide with and return from external objects form an (m×n) matrix, which is referred to as a range image. Each point in the LiDAR point cloud image may include depth (i.e., range) information, as well as additional details such as intensity, azimuth, inclination, and other additional information of returned laser pulse (e.g., reflectivity, return number, or time-of-flight, etc.). Range images may be used for AI training with large datasets, such as Waymo™ Open Dataset (WOD).

Range view (RV) refers to a technique that converts 3D point clouds into 2D or 2.5D scenes, allowing LiDAR 3D maps to be represented in a way that is more intuitively understandable to humans, resembling an analog drawing rather than a collection of countless points (e.g., as a panoramic image showing lane boundaries and obstacles in a simplified layout, etc.). In a range view image, a 3D LiDAR point cloud image may have 2D coordinates, but a 3D laser-related information (angle, inclination, intensity, etc.) recorded in response to obtaining the range image may not be discarded. A 3D LiDAR image's (x, y, z) coordinates may be transformed into a 2D range view image by applying a width variable to the (x, y) coordinates to obtain the coordinates of one axis in two dimensions and applying a height variable and range image information indicating a range (depth) to the (z) coordinate to obtain the coordinates of another axis in two dimensions (e.g., mapping lateral position to image width and vertical angle or elevation to image height, etc.).

Furthermore, the AI algorithm according to the present disclosure may include a convolutional neural network (CNN), which is an AI training module frequently used to extract features (or feature points) from image data (e.g., edges, corners, textures, or object outlines, etc.). For this purpose, there are commercially available datasets including tens of thousands of images, and CNNs currently exist in versions that can process images from one-dimensional to three-dimensional. For example, results from a range view image processing tool are trained by a CNN neural network to perform a function of helping AI accurately recognize objects in an image.

Objects around autonomous vehicles may be ultimately recognized by machines, so generation of a ground truth (GT) bounding box on the aforementioned autonomous driving sensor map may also be a critical step in object recognition. In machine learning, GT (ground truth) is a term used to indicate an original or actual value of data that AI is trying to learn (e.g., the real position of a pedestrian, car, or traffic cone, etc.). Typically, a bounding box with a box-shaped boundary may be considered a type of image annotation applied to a point cloud image.

For example, the AI module may retrieve labels to recognize objects and group various objects (e.g., grouping multiple detected vehicles into a vehicle class or pedestrians into a pedestrian class, etc.). Of course, an interval of 3D data points used to output a GT bounding box may also be set, and one GT bounding box may be set to include 50 to 1000 cloud points (e.g., depending on the object's size or scan density, etc.).

Of course, the GT annotation may not exist in raw data captured by sensors such as the radar (or LiDAR) 120 while the vehicle is driving. The processor 110 may have to recognize objects belonging to various classes, such as a road sign, a crosswalk, a pedestrian, another vehicle, a center lane, or a guardrail, etc., as objects, and GT annotation may serve as a means to measure object recognition errors by comparing object determination results recognized by the AI algorithm of the processor 110 with actual outcomes, and they are sometimes used to evaluate AI performance. The GT bounding box, which is applied to an original image in the form of annotation, may be set manually by a user, but there is also a commercially available GT calculation tool, such as grid-striding (e.g., dividing a space into grid cells and labeling each cell's contents, etc.).

In a case where the AI object recognition module is driven, predicted bounding boxes may also be observed. A result recognized by the processor 110 as an object of a specific class from original image data obtained from the sensor 120, etc., may appear in a form of another bounding box similar to the GT bounding box. Unlike the GT bounding box, the predicted bounding boxes may be computational results of autonomous driving AI. The predicted bounding box may match the GT bounding box, but the predicted bounding box may not match the GT bounding box or may not overlap the GT bounding box at all (e.g., due to sensor noise, occlusion, or misclassification, etc.).

For reference, the predicted bounding boxes alone may not definitively determine that an object of a specific class actually exists at a certain position, so the predicted bounding boxes may be usually called P-Boxes (probability boxes) or predicted bounding boxes.

Segmentation processing performed after preprocessing refers to, for example, displaying a specific part of a road (e.g., a traffic light) in red and the rest (asphalt road) in blue (e.g., for class-based color labeling, etc.). Clustering point clouds into certain groups and generating P-Boxes may also be done at the segmentation operation. For reference, there exists a technique called cluster expansion, where an expansion target may include all points within an epsilon distance (a minimum distance constituting a cluster) from a seed point (e.g., expanding a group of adjacent car-surface points into a full vehicle object, etc.).

During segmentation processing, clustering and P-Box generation may be performed based on a point cloud. In short, an AI network performing segmentation is used to obtain a point label from the autonomous driving sensor 120 (e.g., labeling a point as road, curb, or obstacle, etc.).

In the present disclosure, a “rule-based” road surface recognition and label fusion technique may be proposed to solve a problem of ground recognition errors occurring during segmentation. Such road surface recognition algorithms may apply any of a variety of techniques, including slope-based road surface recognition, grid-based road surface recognition, and other non-planar-based road surface recognition (e.g., for detecting curved ramps, uneven terrain, or multi-elevation surfaces, etc.). However, the present disclosure proposes to adopt a slope-based road surface recognition technique in a case of recognizing a road surface inside a tunnel.

For reference, semantic segmentation indicates a task of assigning a unique class label to each point in a point cloud generated by the LiDAR 120. Semantic segmentation in LiDAR image processing is a technique used to determine and utilize meaningful information from LiDAR data for object recognition or scene reconstruction, which are essential for implementing autonomous driving. Various semantic segmentation AI models, (e.g., a projection-based method, a point-based method, and a sparse convolution-based method, etc.) may be applied. For example, a result of semantic segmentation may be an outcome of AI computations performed by the processor 110 using a NVIDIA DRIVE™ AGX system, and through such a configuration, various colors may be added to a LiDAR point cloud image (e.g., coloring vehicles in red, pedestrians in yellow, or road surfaces in gray, etc.).

After the segmentation process as above, the sensor image may go through a process called postprocessing. The postprocessing refers to converting point cloud data into 3D maps or modeling, to extract meaningful information for autonomous driving. Postprocessing may also include a process of finally removing noise and errors from the point cloud image, recognizing objects such as vehicles and pedestrians from the point cloud, and, if necessary, registering point cloud information by attaching a unique identifier thereto (e.g., for object tracking, localization, or scene mapping, etc.).

FIG. 2 shows an example algorithm 200 to for recognizing an object and measuring a displacement using multiple point data input from an AI module and an autonomous driving sensor. However, for better understanding and ease of description, will be referred to as necessary in a case of describing each operation of FIG. 2.

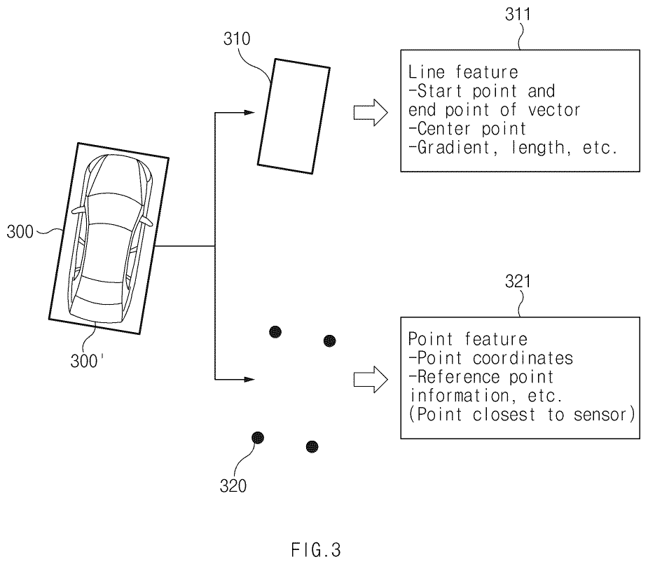

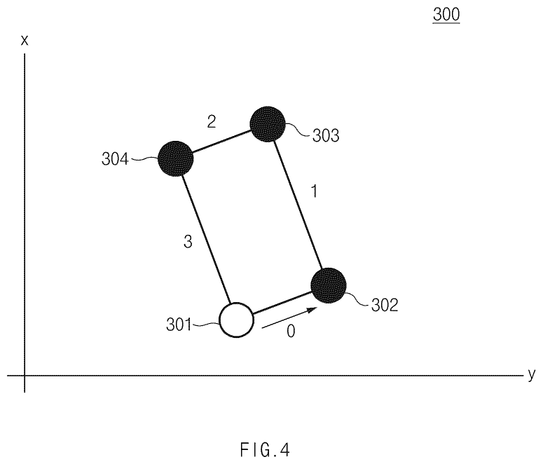

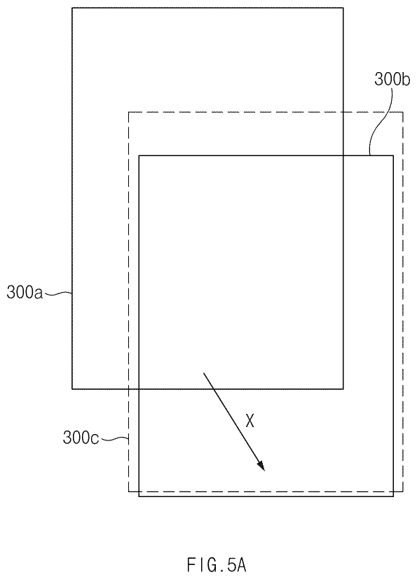

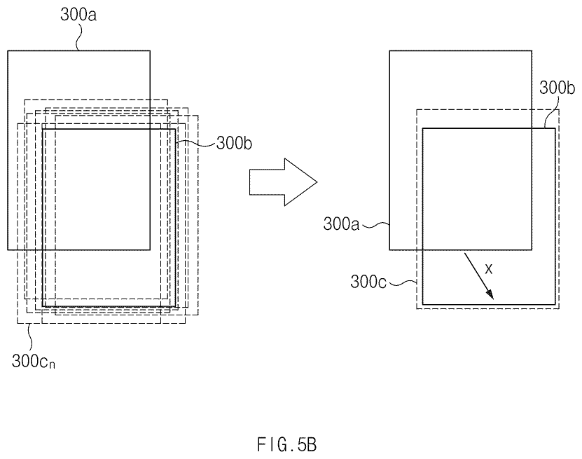

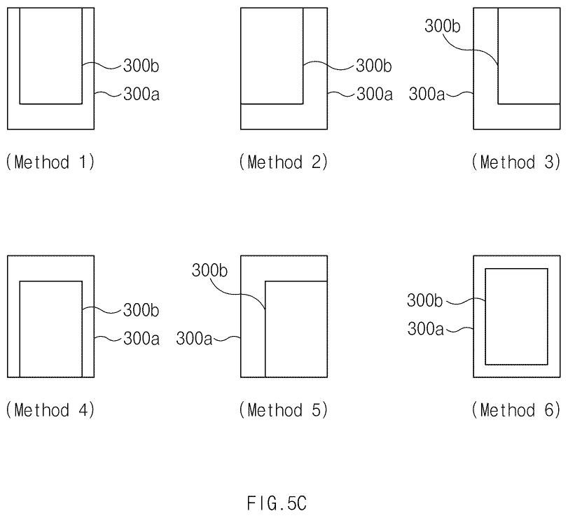

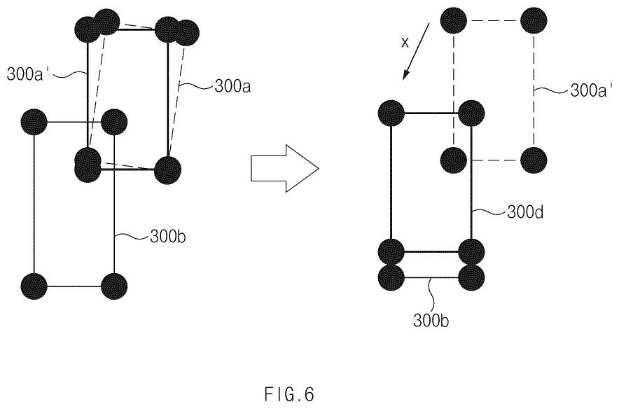

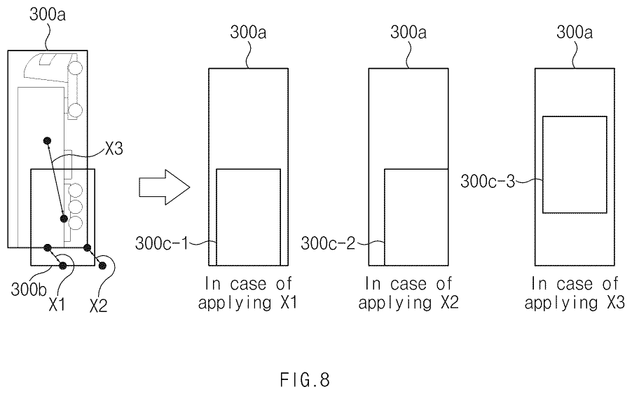

FIG. 3 shows an example view for describing components of a box feature point used for displacement measurement. FIG. 4 shows an example view for describing a method of aligning shape information of a P-Box prior to displacement measurement. FIG. 5A to FIG. 5C show example views for describing various methods of determining a plurality of candidate transition matrices that provisionally represent displacement values between a first P-Box and a second P-Box (e.g., alignment using corner points, center points, or side centers, etc.). FIG. 6 shows an example process of overlapping box shapes for displacement measurement. FIG. 7 shows an example view visually representing various variables used in LF distance and PF distance determination (e.g., vector length, orientation, or distance between points, etc.). FIG. 8 shows an example view for describing a reason for introducing weights to deal with errors that may occur in reliability measurement based on an LF distance (e.g., adjusting for size differences or shape distortions, etc.).

Referring to FIG. 2, an AI module included in the processor 110 according to the present disclosure may generate first and second shape information related to a first P-Box, obtained by incorporating a current line feature (LF) and a point feature (PF) of an object recognized by the LiDAR 120 in Operation S100, and a second P-Box, obtained by incorporating a past line feature and point feature of the object (e.g., from a previous time step or frame, etc.).

Herein, for a clear understanding of Operation S100, FIG. 3 may be referred to. FIG. 3 illustrates an example object of a vehicle 300′ belonging to a passenger car class. The LiDAR 120 may generate multiple point clouds capable of recognizing the vehicle 300′ by emitting a laser beam and measuring intensity and reflection time of the laser beam that is reflected by particles forming the vehicle 300′ and returned (e.g., by bouncing off surfaces such as windows, doors, or mirrors, etc.).

The multiple point clouds may go through a segmentation and clustering process to output a P-Box 300 in a quadrangular shape as shown in FIG. 3 (e.g., forming a rectangle around a car, a truck, or a pedestrian, etc.). P-Box has been described in detail previously, so a redundant description will be omitted herein.

However, the shape information mentioned in Operation S100 may be obtained by decomposing the P-Box 300 of FIG. 3 into line components and point components. For example, based on line components 310 of the P-Box 300, a so-called line feature (hereinafter referred to as “LF”) may be obtained, and the line feature 311 may include information about start and end points of vectors of four sides constituting the line component 310, a center point of the vector, and a gradient and a length of the vector (e.g., the orientation of a car's front bumper, the length of the vehicle, or the direction of travel, etc.).

From the point component 320 of the P-Box 300, a so-called point feature (hereinafter referred to as “PF”) may be obtained. The point feature 321 may include, e.g., coordinate information corresponding to four vertex points of the P-Box 300, reference point information, or a closest approach to the sensor, etc. For reference, a reference point refers to a specific point where a vehicle 300′ is positioned closest to a specific LiDAR sensor 120.

A box feature indicates a concept that collectively refers to the line feature 311 and the point feature 321, i.e., LF and PF (e.g., capturing both the overall outline and the corner locations of an object, etc.).

For reference, in Operation S100, a process may be executed to correct an alignment sequence between a current LF and PF and a past LF and PF (e.g., reordering vertices, rotating boxes to match orientation, or aligning reference points, etc.). This point will be further described with reference to FIG. 4.

Referring to FIG. 4, for example, based on a 0^{th} point 301, which has a smallest x-axis coordinate value, line numbers of LF may be assigned as 0, 1, 2, and 3, for example, in a counterclockwise direction or a clockwise direction (e.g., assigning labels to the sides of a rectangle representing the front, rear, left, and right of a vehicle, etc.).

As mentioned above, the present disclosure focuses on the measurement of displacement and velocity, so for instance, it proposes a method to determine the displacement by comparing the currently measured box feature of the vehicle 300′ with the box feature measured at a past point in time, and based on this, to determine the velocity (e.g., by tracking how far a car moves between frames, or how its orientation changes after turning, etc.). However, in order to accurately measure displacement, line numbers between the currently measured P-Box 300a (in FIG. 5A) and the previously measured P-Box 300b (in FIG. 5A) may have to be aligned in a same order (e.g., ensuring the left side of the box in one frame matches the left side in the next frame, etc.).

Accordingly, in a case where a position of the 0^{th} point 301 changes between past and present time points as the vehicle 300′ rotates, a 0^{th} line illustrated in FIG. 4 may be moved to a 1^{st} line, which is longer (e.g., as might occur if the car turns or slides sideways, etc.). In the instant case, line alignment may need to be re-done by comparing positions of an end point of 0th line (i.e., a point 302 among points 301, 302, 303, and 304 in FIG. 4) (e.g., rotating or shifting the labels so that each side corresponds to its previous position, etc.) and a starting point of a 3^{rd} line (i.e., a point 304 in FIG. 4). Of course, in a case where the line alignment did not change between the past and present time points, there may be no need to do this alignment (e.g., if the vehicle moves straight without rotation, etc.).

Referring again to FIG. 2, the AI module according to the present disclosure may determine a plurality of candidate transition matrices that provisionally represent displacement values between the first P-Box and the second P-Box based on first shape information and second shape information in Operation S200 (e.g., by generating several possible movement patterns, such as shifts, rotations, or scalings, etc.).

For example, any one of the multiple candidate transition matrices, X, has a relationship shown in Equation 1 and Equation 1-1 between first shape information, B, formed of matrices, and second shape information, A, formed of matrices (e.g., treating the coordinates as arrays and applying matrix operations, etc.).

$$A = X \cdot B \qquad ( Equation 1 )$$

$$X = A \cdot {B}^{- 1} \qquad [ Equation 1 - 1 ]$$

Herein, referring to FIG. 5A, the first P-Box 300a currently measured and the second P-Box 300b) measured in the past are illustrated. As mentioned above, the shape information constituting the first P-Box 300a may be formed of LF and PF types, and both the LF and the PF may include measurement values for various items, so first shape information for the first P-Box 300a may be structured as a multidimensional matrix (e.g., containing values for length, width, angle, and position, etc.). This may correspond to B in Equation 1 above. A reason for referring to the first shape information as B (determined from 300a in FIG. 5A) is that the present disclosure assumes the result of applying the transition matrix X (determined from 300c in FIG. 5A) to the current shape information may represent the past second shape information A (determined from 300b in FIG. 5A).

Accordingly, the ‘arrow’ shown in FIG. 5A may correspond to a transition matrix vector X that the present disclosure aims to derive (e.g., representing movement, rotation, or transformation between two positions, etc.).

However, as shown in FIG. 2, the present disclosure may determine reliability scores based on LF-based line distances or PF-based point distances for each of the multiple candidate transition matrices in Operation S300; accordingly, the transition matrix obtained in Operation S200 is merely in a ‘candidate’ state, and multiple candidates may have to consequently be obtained in Operation S200. For example, each candidate may correspond to a possible way the object could have moved, such as shifting left, rotating slightly, or stretching, etc. However, as ultimately shown in FIG. 5B, a transition matrix 300c may be selected (e.g., based on the highest reliability score from among multiple candidate transition matrices 300cₙ) from among multiple candidate transition matrices 300cₙ, as depicted on a right side of FIG. 5B (e.g., selecting the candidate that best matches the actual observed movement, etc.).

FIG. 5C illustrates example methods for deriving the multiple candidate transition matrices 300cₙ. For example, Method 1 involves aligning center points of the upper sides of the first P-Box 300a and the second P-Box 300b (e.g., aligning rooflines of two vehicles, upper edges of a truck or a bus, etc.), followed by deriving a candidate transition matrix X between the first P-Box 300a and the second P-Box 300b, and Method 2 represents a process in which points positioned at upper-left corners of the first P-Box 300a and the second P-Box 300b are aligned (e.g., matching the front-left corners of a car, etc.), and then a candidate transition matrix X between the two P-Boxes is derived. Method 3 involves aligning points positioned at upper-right corners of the first P-Box 300a and the second P-Box 300b, Method 4 aligns center points of lower sides of the first P-Box 300a and the second P-Box 300b, Method 5 uses points positioned at lower-right corners, and Method 6 aligns centers of the first P-Box 300a and the second P-Box 300b. Such approaches may account for real-world variations like imperfect sensor readings, partial occlusions, or asymmetric object shapes, etc. By applying a method like that shown in FIG. 5C, for instance, a total of six candidate transition matrices 300cₙ as depicted on a left side of FIG. 5B may be obtained. Among the various candidates 300cₙ, those with higher box feature matching scores may be selected as the candidates 300cₙ. Of course, the candidates 300cₙ obtained in this manner may each include various types of information, such as box movement data and rotation data (e.g., representing not only how far the box moved, but also its orientation or scaling, etc.).

In summary, the method illustrated in FIG. 5C may be understood as a process of generating multiple candidate transition matrices by comparing positional information included in each of the first shape information and the second shape information (e.g., comparing the location of each corner, side, or center point, etc.).

However, Operation S200 according to the present disclosure may also be implemented through a singular value decomposition (SVD) process, in addition to the method shown in FIG. 5C. In the instant case, the candidate transition matrix X may be determined by following Equation 2 (e.g., leveraging mathematical tools to find the best fit transformation, etc.).

$$X = A \cdot {B}^{- 1} \approx A \cdot {B}^{+} = A \cdot {V}_{B} {\sum }_{B}^{+} {U}_{B}^{T} \qquad ( Equation 2 )$$

Herein, B⁺ indicates a pseudo-inverse matrix of a non-square matrix B, U_{B} indicates an m×m orthogonal matrix associated with the matrix B,

$${\sum }_{B}^{+}$$

indicates all m×n diagonal matrix associated with the matrix B (in which values on the diagonal are non-negative, and all the values outside the diagonal are zero), while V_{B} represents an n×n orthogonalmatrix associated with the matrix B (e.g., U and V can represent rotations or flips, Σ can represent stretching or compressing, etc.).

For example, to recompute the current object's position by applying various displacement values, it may be necessary to predict box position parameters for matching current box features with past box features, and the present disclosure proposes that, in addition to the position-based method presented in FIG. 5C, the candidate transition matrix X may be derived using a singular value decomposition (SVD) technique. This is because the candidate transition matrix X, derived according to Equation 2, may represent a displacement vector that enables a best match between the current and past box features (e.g., a transformation that most closely matches the current and past box features for minimizing the overall difference between them, etc.). However, utilizing SVD may increase a computational load on the processor 110, the present disclosure proposes an alternative method such as that shown in FIG. 5C (e.g., to reduce processing time or hardware demands, etc.).

Before moving on to Operation S300, an operation of rotating the first shape information such that a heading of the first shape information is to be aligned with that of the second shape information may be additionally executed in Operation S200 (e.g., rotating the current box to match the orientation of the previous box before comparing them, etc.).

For example, referring to FIG. 6, before overlapping the first P-Box 300a at a time t with the second P-Box 300b at a time (t−1), the first P-Box 300a may be rotated into a rotated P-Box 300a′ based on a heading difference between the two boxes 300a and 300b to ensure alignment of their overlapped shape. Thereafter, applying the candidate transition matrix X, as shown on a right side of FIG. 6, the first P-Box 300a and the second P-Box 300b at a time (t−1) may be overlapped in terms of shape. However, the first P-Box 300a, overlapped after rotation in this manner, may be conveniently labeled with a reference number 300d to clearly indicate that reference number 300d represents rotated appearance of the first P-Box 300a rather than the first P-Box 300a itself (e.g., highlighting the adjustment in orientation, etc.).

Referring back to FIG. 2, in Operation S300, a reliability score based on a LF-based line distance or a PF-based point distance may be determined for each of the candidate transition matrices, in order to determine a transition matrix based on the reliability score (e.g., determine which candidate transition matrix best explains the movement of the object by calculating which candidate transition matrix minimizes the error between observed and predicted positions, etc.).

Herein, the LF-based line distance LineDist[i] may be determined for the i^{th} candidate transition matrix among the multiple candidate transition matrices according to Equation 3 (e.g., for each possible movement, the method determines how well the sides of the boxes align by summing distances between endpoints and midpoints of current and previous lines, etc.).

$$LineDist [ i ] = ( {d}_{1} + {d}_{2} ) + ( {d}_{1}^{′} + {d}_{2}^{′} ) + dist ( \frac{( \tilde{p} + \tilde{q} )}{2} , \frac{( {P}_{d} + {Q}_{d} )}{2} ) \qquad ( Equation 3 )$$

\tilde{p} and \tilde{q} are the two points (e.g., points of box corners) of the previously measured side 311b of a box (e.g., a P-Box). d₁ is a distance between p and the currently measured side 311a. d₂ is a distance between q and the currently measured side 311a.

$${d}_{1}^{′}$$

is a distance between P_{d} and the previously measured side 311b.

$${d}_{2}^{′}$$

is a distance between Q_{d} and the previously measured side 311b.

$$\frac{( \tilde{p} + \tilde{q} )}{2}$$

is the midpoint of \tilde{p} and \tilde{q}.

$$\frac{( {P}_{d} + {Q}_{d} )}{2}$$

is the midpoint of P_{d} and Q_{d}. The function dist(x,y) is the distance between the two points x and y.

Furthermore, the PF-based point distance PointDist[i] may be determined for the i^{th} candidate transition matrix among the multiple candidate transition matrices according to Equation 4 (e.g., by comparing the position of box corners or reference points, etc.).

$$PointDist [ i ] = dist ( \tilde{p} , {P}_{d} ) + d i s t ( \tilde{q} , {Q}_{d} ) \qquad ( Equation 4 )$$

Variables d₁, \tilde{p}, Q_{d}, etc., used in Equations 3 and 4 may be visually clarified through FIG. 7. For example, FIG. 7 illustrates a currently measured side 311a and a previously measured side 311b, and values used in Equations 3 and 4 may each be measured in a same manner as that of shown in FIG. 7 (e.g., using real-world vehicle dimensions, LiDAR sensor positions, or detected object edges, etc.).

In summary, Equation 3 may be used for an LF-based score computation method using a line distance between a LF of a current object and a LF of a past object, while Equation 4 may be used for a PF-based score computation method using a point distance between a PF of the current object and a PF of the past object (e.g., calculating how much the shape and location have shifted, etc.).

However, Equation 3 and Equation 4 may each be further subdivided into Equations 3-1, 3-2, 3-3, 4-1, 4-2, and 4-3, enabling more detailed computations (e.g., incorporating weights, gradients, or using min/max/average values, etc.). For example, Equation 3-1 may represent the basic computation method for LF-based reliability scores, whereas Equation 3-2 may be a modified version that additionally considers variables W and σ by incorporating a gradient Grad into the calculation of LF-based reliability scores (e.g., accounting for both length and angle differences, etc.). Accordingly, Equation 3 and Equation 4 may be understood as having BASIC, TYPE1, and TYPE2 as variations (e.g., to allow flexibility for different driving conditions or object types, etc.). For the ith candidate transition matrix among the multiple candidate matrices (e.g., i=1, 2, 3, . . . , N):

$$LF Score ( BASIC ) = {\sum }_{i} L i n e D i s t [ i ] \qquad [ Equation 3 - 1 ]$$

$$LF Score ( TYPE 1 ) = {\sum }_{i} L i n e D i s t [ i ] + \vert {Grad}_{current} [ i ] - G r a {d}_{previous} [ i ] \vert \qquad [ Equation 3 - 2 ]$$

Here, Grad_{current} and Gradₚᵣₑᵥᵢₒᵤₛ are a gradient (inclinations) of the line constituting the box where Grad_{current} is a currently observed gradient of each line constituting the box, and Gradₚᵣₑᵥᵢₒᵤₛ is a previously observed gradient of each line constituting the box.

As shown in Equation 3-2, the processor 110 calculates an LF-based reliability score LF Score by using a difference between the currently observed gradient of each line constituting the box and the previously observed gradient of each line constituting the box.

$$LF Score ( TYPE 2 ) = {\sum }_{i} W [ i ] \cdot LineDist [ i ] + \vert {Grad}_{current} [ i ] - G r a {d}_{p r e v i o u s} [ i ] \vert \qquad [ Equation 3 - 3 ]$$

(But herein, there is a relationship W=σ if LineFeature[i]==reference LF (closest line feature), w=1/σ otherwise σ=|Length_{current}[1]−Lengthₚᵣₑᵥᵢₒᵤₛ[1]|+1) (e.g., assigning greater importance to the side closest to the vehicle, or adjusting based on size difference, etc.)

Here, Length_{current} and Lengthₚᵣₑᵥᵢₒᵤₛ are a length of the line constituting the box where Length_{current} is a currently observed length of each line constituting the box, and Lengthₚᵣₑᵥᵢₒᵤₛ is a previously observed length of each line constituting the box.

As shown in Equation 3-3, the processor 110 calculates an LF-based reliability score LF Score by using a difference between the currently observed length of each line constituting the box and the previously observed length of each line constituting the box.

$$PF Score ( BASIC ) = Avg ( PointDist [ i ] ) \qquad [ Equation 4 - 1 ]$$

$$PF Score ( TYPE 1 ) = max ( PointDist [ i ] ) + Avg ( PointDist [ i ] ) \qquad [ Equation 4 - 2 ]$$

$$PF Score ( TYPE 2 ) = max ( PointDist [ i ] ) + min ( PointDist [ i ] ) + Avg ( PointDist [ i ] ) \qquad [ Equation 4 - 3 ]$$

$$( e . g . , considering not only average \\ but also extreme shifts between reference points , etc . )$$

Referring again to FIG. 2, in Operation S400, a transition matrix (e.g., an optimal transition matrix) may be determined based on the reliability score to determine the displacement, ultimately enabling measurement of velocity of the object (e.g., calculating how quickly an object, such as another vehicle or pedestrian, is moving relative to the host vehicle, etc.).

However, in Operation S400, in a case where a difference in length between the first shape information and the second shape information exceeds a certain threshold, it may be preferable to apply a weighting factor w to adjust a result of Equation 3 (e.g., to avoid overestimating movement when the object changes size due to perspective or occlusion, etc.).

A reason for this will be described by referring to FIG. 8 (e.g., showing how adjusting the weights can prevent errors when one object appears much larger or smaller between measurements, etc.).

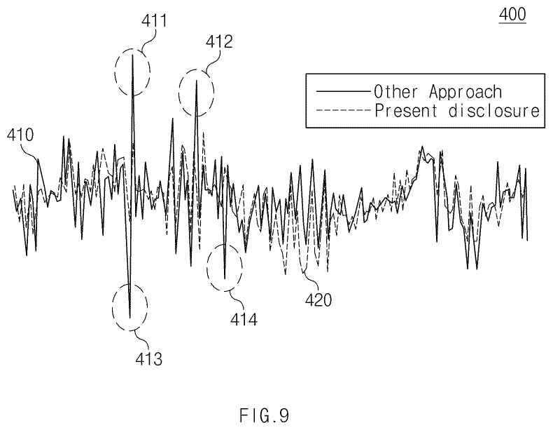

FIG. 9 shows an example view of comparing a lateral component of a displacement (i.e., velocity converted per unit time) actually measured according to an example of the present disclosure with that of a displacement measured according to other approach (e.g., comparing the new method's results against traditional calculation methods, etc.).

For example, in Operation S400, matching of box features may be performed using features of the current and past objects, but as depicted on a left side of FIG. 9, in a case where shapes of the past and current objects change significantly (e.g., a size of a box 300a is much larger than that of a box 300b), there may be a concern that, despite X2 being correctly predicted among the candidate transition matrices X1, X2, and X3, a reliability score of X3 may be the highest based solely on distance criteria, leading to displacement and velocity measurements based on X3. in other words, in a case of X1 and X2, a situation shown in FIG. 9 occurs as a maximum value of the line distance becomes excessively large, resulting in a lower reliability score, and in the instant case, it may be necessary to modify a LF score computation formula by increasing a weight value of a reference LF.

FIG. 9 shows an example view of comparing a lateral component of a displacement (i.e., velocity converted per unit time) actually measured according to an example of the present disclosure with that of a displacement measured according to other approach.

According to an experiment result 400 illustrated in FIG. 9, horizontal component values of velocity measured according to the other approach 410 includes numerous outliers, such as reference numerals 411, 412, 413, and 414, whereas horizontal component values of velocity measured according to the present disclosure 420 may be confirmed to be free of such outliers.

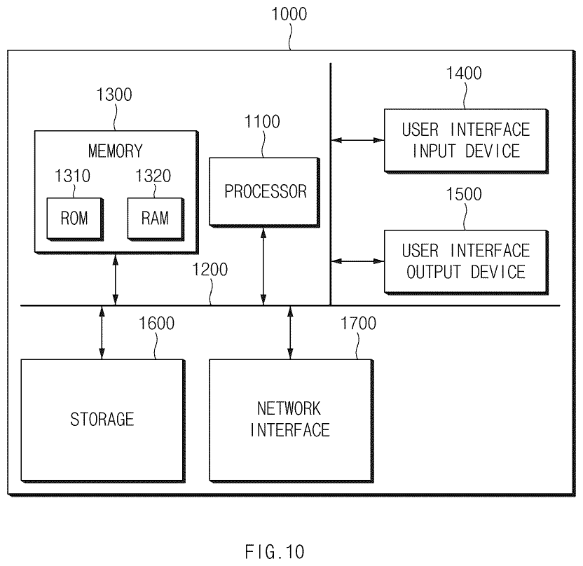

FIG. 10 shows an example computing system 1000 for autonomous vehicle control and object recognition computation.

Referring to FIG. 10, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600 (e.g., SSD, flash memory, or HDD, etc.). The memory 1300 and the storage 1600 may include various types of volatile or nonvolatile storage media. For example, the memory 1300 may include a read only memory (ROM) and a random access memory (RAM) (e.g., DRAM or SRAM).

Accordingly, steps of a method or algorithm described in connection with the examples included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM (e.g., SSD, USB drive, or optical media).

An exemplary storage medium is coupled to the processor 1100, which can read information from and write information to the storage medium. Alternatively, the storage medium may be integrated with the processor 1100. The processor and the storage medium may reside within an application specific IC (ASIC). The ASIC may reside within a user terminal (e.g., an onboard vehicle controller or mobile computing platform). Alternatively, the processor and the storage medium may reside as separate components within the user terminal.

For example, a first example of the present disclosure relates to a system for recognizing an object using an AI module and an autonomous driving sensor, including a processor configured to include an object recognition module that recognizes an object existing in a surrounding environment based on multiple point data input from the autonomous driving sensor as part of the AI module, and a memory configured to store the input multi point data, wherein the AI module performs a first operation of generating first and second shape information related to a first P-Box, obtained by incorporating a current line feature (LF) and a point feature (PF) of an object, and a second P-Box, obtained by incorporating a past line feature and point feature of the object, a second operation of determining a plurality of candidate transition matrices that provisionally represent displacement values between the first P-Box and the second P-Box based on the first shape information and the second shape information, and a third operation of determining the displacement values by determining a reliability score based on a LF-based line distance or a PF-based point distance for each of the candidate transition matrices and determining a transition matrix based on the reliability score.

In a case of a system according to a second example of the present disclosure, the first operation may include an operation of correcting an alignment order between the current LF and PF and the past LF and PF.

In a case of a system according to a third example of the present disclosure, the present and past PFs may be measured by setting a point closest to the autonomous driving sensor among the points as a reference point.

In a case of a system according to a fourth example of the present disclosure, any one X of the multiple candidate transition matrices may have a relationship shown in Equation 1 and Equation 1-1 between first shape information B formed of matrices, and second shape information A formed of matrices.

$$A = X \cdot B \qquad [ Equation 1 ]$$

$$X = A \cdot {B}^{- 1} \qquad [ Equation 1 - 1 ]$$

In a case of a system according to a fifth example of the present disclosure, the second operation may be performed by a singular value decomposition (SVD) process, in which case the candidate transition matrix X is determined by following Equation 2.

$$X = A \cdot {B}^{- 1} \approx A \cdot {B}^{+} = A \cdot {V}_{B} {\sum }_{B}^{+} {U}_{B}^{T} \qquad [ Equation 2 ]$$

Herein, B⁺ indicates a pseudo-inverse matrix of a non-square matrix B, U_{B} indicates an m×m orthogonal matrix associated with the matrix B,

$${\sum }_{B}^{+}$$

indicates an m×n diagonal matrix associated with the matrix B (in which values on the diagonal are non-negative, and all the values outside the diagonal are zero), while V_{B} represents an n×n orthogonalmatrix associated with the matrix B (e.g., U and V can represent rotations or flips, E can represent stretching or compressing, etc.).

In a case of a system according to a sixth example of the present disclosure, the multiple candidate transition matrices may be generated by comparing positional information included in each of the first shape information and the second shape information.

In a case of a system according to a seventh example of the present disclosure, the third operation may include an operation of rotating the first shape information such that a heading of the first shape information is to be aligned with that of the second shape information prior to determining the reliability score.

In a case of a system according to an eighth example of the present disclosure, the LF-based line distance LineDist[i] may be determined for i^{th} candidate transition matrix among the multiple candidate transition matrices according to Equation 3.

$$LineDist [ i ] = ( {d}_{1} + {d}_{2} ) + ( {d}_{1}^{′} + {d}_{2}^{′} ) + dist ( \frac{( \tilde{p} + \tilde{q} )}{2} , \frac{( {P}_{d} + {Q}_{d} )}{2} ) \qquad [ Equation 3 ]$$

In a case of a system according to a ninth example of the present disclosure, the PF-based point distance PointDist[i] may be determined for i^{th} candidate transition matrix among the multiple candidate transition matrices according to Equation 4.

$$PointDist [ i ] = dist ( \tilde{p} , {P}_{d} ) + d i s t ( \tilde{q} , {Q}_{d} ) \qquad [ Equation 4 ]$$

In a case of a system according to a tenth example of the present disclosure, a weighting factor w to adjust a result of Equation 3 may be applied in a case where a difference in length between the first shape information and the second shape information exceeds a certain threshold.

An eleventh example of the present disclosure relates to a method for recognizing an object by a plurality of point data input from an AI module and an autonomous driving sensor, including operations, performed by the AI module, including a first operation of generating first and second shape information related to a first P-Box, obtained by incorporating a current line feature (LF) and a point feature (PF) of an object, and a second P-Box, obtained by incorporating a past line feature and point feature of the object, a second operation of determining a plurality of candidate transition matrices that provisionally represent displacement values between the first P-Box and the second P-Box based on the first shape information and the second shape information, and a third operation of determining the displacement values by determining a reliability score based on a LF-based line distance or a PF-based point distance for each of the candidate transition matrices and determining a transition matrix based on the reliability score.

The present disclosure proposes a method of determining a displacement by verifying the displacement through feature comparison of shapes instead of an existing representative point determination method in order to determine a more accurate displacement value in obtaining a displacement of an object being observed.

For example, a method of determining a representative point of a moving object to determine a displacement and estimating velocity may lack a verification process to ensure accuracy of the determined displacement, leading to velocity estimation based on a minimum displacement value to reduce a displacement error, where the velocity is defined as a displacement value per unit time. However, following such method, in a case where the displacement of the actual object changes abruptly or shape errors occur, accurate velocity estimation may become impossible, necessitating a complex correction method. Of course, a resulting computational overhead and difficulty in logic management may be problems.

On the other hand, the present disclosure proposes a method of estimating a more accurate velocity by determining a score for each (candidate) movement displacement and adopting a most accurately determined movement displacement as a final displacement value. As suggested in the present disclosure, in a case where the velocity is determined after confirming that the displacements are accurately determined for each moving displacement, a sufficient verification operation has already been performed before velocity determination, and a most accurate value among the displacements that may currently be determined may be selected to estimate the velocity, so accuracy of velocity measurement is improved compared to the others described above.

Furthermore, by determining the reliability score for each movement displacement as in the present disclosure, it may possible to numerically confirm which movement displacement is a better choice. Accordingly, a logic manager may compare numerically the most accurate displacement for each situation without having to manually check it, so accurate situational determination may be possible in various actual driving situations of autonomous driving.

Furthermore, various effects in addition to effects described above from the present disclosure by those skilled in the art are provided through the detailed description of the present disclosure and the attached drawings.

The above description is merely illustrative of the technical idea of the present disclosure, and those skilled in the art to which the present disclosure pertains may make various modifications and variations without departing from the essential characteristics of the present disclosure.

Therefore, the examples disclosed in the present disclosure are not intended to limit the technical ideas of the present disclosure, but to explain them, and the scope of the technical ideas of the present disclosure is not limited by these examples. The protection range of the present disclosure should be interpreted by the claims below, and all technical ideas within the equivalent range should be interpreted as being included in the scope of the present disclosure.

What is claimed is:

1. An apparatus of a vehicle, the apparatus comprising:
a processor; and
a memory storing at least one instruction that, when executed by the processor communicating with the memory, is configured to cause the apparatus to:
generate first shape information related to a first predicted bounding box (P-Box), wherein the first P-Box is obtained by incorporating a current line feature (LF) and a current point feature (PF) of an object in a surrounding environment of the vehicle,
generate second shape information related to a second P-Box, wherein the second P-Box is obtained by incorporating a past LF and a past PF of the object, wherein the object is recognized based on multiple point data input from a sensor of the vehicle, and wherein the multiple point data input is part of an artificial intelligent model,
based on the first shape information and the second shape information, determine a plurality of candidate transition matrices that provisionally represent displacement values between the first P-Box and the second P-Box,
based on an LF-based line distance or a PF-based point distance, determine, for each of the plurality of candidate transition matrices, a reliability score,
select, based on the reliability score, a transition matrix among the plurality of candidate transition matrices, wherein the transition matrix represents a displacement value between the first P-Box and the second P-Box, output a signal indicating the displacement value, and
control, based on the signal, autonomous driving of the vehicle.

2. The apparatus of claim 1, wherein the at least one instruction that, when executed by the processor communicating with the memory, is configured to cause the apparatus to generate the first shape information and the second shape information by adjusting an alignment order between the current LF, the current PF, the past LF, and the past PF.

3. The apparatus of claim 1, wherein the at least one instruction that, when executed by the processor communicating with the memory, is configured to cause the apparatus to measure the current PF and the past PF by setting a reference point, wherein the reference point is a point, among points represented by the multiple point data, closest to the sensor.

4. The apparatus of claim 1, wherein a candidate transition matrix, X, of the plurality of candidate transition matrices, is determined such that the first shape information corresponding to matrix B and the second shape information corresponding to matrix A satisfy the following relationship:
$$A = X \cdot B$$
and X is determined as:
$$X = A \cdot {B}^{- 1} .$$

5. The apparatus of claim 4, wherein the candidate transition matrix, X, is determined by a singular value decomposition (SVD) process based on:
a product of the matrix A, an m×m orthogonal matrix associated with the matrix B, an m×n diagonal matrix associated with the matrix B, and an n×n orthogonal matrix associated with the matrix B.

6. The apparatus of claim 4, wherein the at least one instruction that, when executed by the processor communicating with the memory, is configured to cause the apparatus to generate the plurality of candidate transition matrices by comparing positional information included in each of the first shape information and the second shape information.

7. The apparatus of claim 1, wherein the at least one instruction that, when executed by the processor communicating with the memory, is configured to cause the apparatus to determine the reliability score by rotating the first shape information such that a heading of the first shape information is aligned with a heading of the second shape information prior to determining the reliability score.

8. The apparatus of claim 1, wherein the LF-based line distance, LineDist[i], is determined for i^{th} candidate transition matrix among the plurality of candidate transition matrices according to Equation 3:
$$LineDist [ i ] = ( {d}_{1} + {d}_{2} ) + ( {d}_{1}^{′} + {d}_{2}^{′} ) + dist ( \frac{( \tilde{p} + \tilde{q} )}{2} , \frac{( {P}_{d} + {Q}_{d} )}{2} ) \qquad [ Equation 3 ]$$
wherein:
P_{d} and Q_{d} are endpoints of a line segment corresponding to the current LF,
\tilde{p} and \tilde{q} are endpoints of a line segment corresponding to the past LF,
d₁ is a perpendicular distance from P_{d} to a line segment defined by \tilde{p} and \tilde{q},
d₂ is a perpendicular distance from Q_{d} to the line segment defined by \tilde{p} and \tilde{q},
d′₁ is a perpendicular distance from p to a line segment defined by P_{d} and Q_{d},
d′₂ is a perpendicular distance from \tilde{q} to the line segment defined by P_{d} and Q_{d}, and
dist (x, y) denotes a Euclidean distance between points x and y.

9. The apparatus of claim 1, wherein the PF-based point distance, PointDist[i], is determined for i^{th} candidate transition matrix among the plurality of candidate transition matrices according to Equation 4:
$$PointDist [ i ] = dist ( \tilde{p} , {P}_{d} ) + d i s t ( \tilde{q} , {Q}_{d} ) \qquad [ Equation 4 ]$$
wherein:
P_{d} and Q_{d} are endpoints of a line segment corresponding to the current LF,
\tilde{p} and \tilde{q} are endpoints of a line segment corresponding to the past LF, and
dist (x, y) denotes a Euclidean distance between points x and y.

10. The apparatus of claim 8, wherein the at least one instruction that, when executed by the processor communicating with the memory, is configured to cause the apparatus to, based on a difference in length between the first shape information and the second shape information exceeding a threshold value, apply a weighting factor w to adjust a result of Equation 3.

11. A method performed by an apparatus of a vehicle, the method comprising:
generating first shape information related to a first predicted bounding box (P-Box), wherein the first P-Box is obtained by incorporating a current line feature (LF) and a current point feature (PF) of an object in a surrounding environment of the vehicle,
generating second shape information related to a second P-Box, wherein the second P-Box is obtained by incorporating a past LF and a past PF of the object, wherein the object is recognized based on multiple point data input from a sensor of the vehicle, and wherein the multiple point data input is part of an artificial intelligent model;
based on the first shape information and the second shape information, determining a plurality of candidate transition matrices that provisionally represent displacement values between the first P-Box and the second P-Box;
based on an LF-based line distance or a PF-based point distance, determining, for each of the plurality of candidate transition matrices, a reliability score;
selecting, based on the reliability score, a transition matrix among the plurality of candidate transition matrices, wherein the transition matrix represents a displacement value between the first P-Box and the second P-Box;
outputting a signal indicating the displacement value; and
controlling, based on the signal, autonomous driving of the vehicle.

12. The method of claim 11, wherein the generating of the first shape information and the second shape information comprises adjusting an alignment order between the current LF, the current PF, the past LF, and the past PF.

13. The method of claim 11, further comprising:
measuring the current PF and the past PF by setting a reference point, among points represented by the multiple point data, closest to the sensor.

14. The method of claim 11, wherein a candidate transition matrix, X, of the plurality of candidate transition matrices, is determined such that the first shape information corresponding to matrix B, and the second shape information corresponding to matrix A satisfy the following relationship:
$$A = X \cdot B$$
and X is determined as:
$$X = A \cdot {B}^{- 1} .$$

15. The method of claim 14, wherein the candidate transition matrix, X, is determined by a singular value decomposition (SVD) process based on:
a product of the matrix A, an m×m complex unitary matrix associated with the matrix B, an m×n diagonal matrix associated with the matrix B, and an n×n complex unitary matrix associated with the matrix B.

16. The method of claim 14, further comprising:
generating the plurality of candidate transition matrices by comparing positional information included in each of the first shape information and the second shape information.

17. The method of claim 11, wherein the determining of the reliability score comprises rotating the first shape information such that a heading of the first shape information is aligned with a heading of the second shape information prior to determining the reliability score.

18. A vehicle comprising:
a sensor;
a driving control circuit configured to control autonomous driving of the vehicle;
a processor; and
a memory storing at least one instruction that, when executed by the processor communicating with the memory, is configured to cause the vehicle to:
obtain, via the sensor, point cloud data representing objects in a surrounding environment of the vehicle,
identify, from the point cloud data, a target object,
generate, for the target object, a present box feature, wherein the present box feature comprises line features and point features corresponding to a current shape of the target object,
retrieve, from the memory, a past box feature associated with the target object, wherein the past box feature comprises line features and point features corresponding to a previous shape of the target object,
generate a plurality of candidate transition matrices representing potential displacements between the present box feature and the past box feature,
determine a reliability score for each candidate transition matrix of the plurality of candidate transition matrices,
based on the reliability scores, select, from the plurality of candidate transition matrices, a transition matrix as an estimated displacement of the target object,
output a signal indicating the estimated displacement of the target object, and
control, via the driving control circuit and based on the signal, autonomous driving of the vehicle.

19. The vehicle of claim 18, wherein the at least one instruction, when executed by the processor communicating with the memory, is configured to, prior to generation of the plurality of candidate transition matrices, cause the vehicle to adjust an alignment order between:
the line features and point features of the present box feature, and
the line features and point features of the past box feature.

20. The vehicle of claim 18, wherein the at least one instruction, when executed by the processor communicating with the memory, is configured to cause the vehicle to, based on a difference in length between the present box feature and the past box feature exceeding a threshold, apply a weighting factor to the reliability score.
